(19) United States
(12) Patent Application Publication
(10) Pub. No.: US 2024/0243257 A1
(43) Pub. Date: Jul. 18, 2024

(54) LAYERED METAL OXIDE/AMINE COMPOSITE MATERIAL AND PREPARATION METHOD AND APPLICATION THEREOF IN MAGNESIUM ION BATTERY

(71) Applicant: SOOCHOW UNIVERSITY, Suzhou (CN)

(72) Inventor: Fengxia GENG, Suzhou (CN)

(21) Appl. No.: 18/012,388

(22) PCT Filed: Jun. 29, 2022
(86) PCT No.: PCT/CN2022/102446

§ 371 Date: Feb. 18, 2024

(30) Foreign Application Priority Data
Aug. 8, 2021 (CN) 202110905211.X

(51) Int. Cl. H01M 4/36; H01M 4/02; H01M 4/48; H01M 4/60; H01M 10/0525; H01M 10/054

(52) U.S. Cl. CPC H01M 4/366; H01M 4/48; H01M 4/60; H01M 10/0525; H01M 10/054; H01M 2004/027

(57) ABSTRACT

Disclosed in the present invention are a layered metal oxide/amine composite material, and a preparation method therefor and an application thereof in a magnesium-ion battery. An anionic metal oxide solution and an amine compound solution are mixed to obtain a precipitate; and then the precipitate is dried to obtain a layered metal oxide/amine composite material. By designing a layered metal oxide/amine compound composite material, adjusting the stacking structure of the material, and using the material as a positive electrode active material for a magnesium-ion battery, the problem of slow diffusion of highly charged magnesium ions in a material lattice is solved, the stability of the layered structure is maintained, and the high electrochemical activity of the metal oxide material is maximized.

### TECHNICAL FIELD

The present invention relates to the technical field of battery, in particular to a layered metal oxide/amine composite material, and its preparation method thereof and its application in magnesium ion battery.

### BACKGROUND

With global fossil fuel consumption and aggravated environmental problems, high-efficiency electrochemical energy storage devices have become an urgent necessity in the past few decades. The magnesium ion battery can obtain high specific capacity and energy density through a two-electron oxidation-reduction process, and it is low in price and high in safety, and has important application prospects in the fields of large-scale energy storage and electromobiles, etc. However, the divalent magnesium ions with high electric density cause slow solid-state diffusion, and the conventional electrode materials cannot realize high-performance magnesium ion storage. The transition metal oxide has the advantages of high theoretical capacity, high oxidation-reduction potential and low cost, and it is an ideal magnesium storage material, but due to the lack of an effective structural assembly and control means, the application of the transition metal oxide in the magnesium ion battery is still very limited, and the problems of low capacity, poor multiplying power and poor cycle performance generally exist, limiting the development of the magnesium ion batteries.

### Technical Problems

The present invention aims to disclose a layered metal oxide/amine composite material which is used as a positive electrode active material for a magnesium ion battery; the problem of slow diffusion of high-charge magnesium ions in material lattices is solved by designing a layered metal oxide/amine compound composite material and adjusting and controlling the stacking structure of the material.

### Technical Solution

In order to achieve the purpose, the technical scheme adopted by the invention is as follows: a layered metal oxide/amine composite material is prepared from anionic metal oxide and amine compound. Specifically, an anionic metal oxide solution and an amine compound solution are mixed to obtain a precipitate; and then the precipitate is dried to obtain the layered metal oxide/amine composite material.

Preferably, the anionic metal oxide solution is mixed with the amine compound solution at room temperature to obtain a precipitate; this is the creativity of the present invention, which uses sheet anionic metal oxide and amine compound as raw materials to obtain the layered material at room temperature for the first time.

Preferably, the drying is freeze drying, water is removed by sublimation, the specific process parameters are not limited, and the conventional powder freeze drying is followed.

The present invention discloses an application of the layered metal oxide/amine composite material in preparation of a metal ion battery, preferably a magnesium ion battery. The layered metal oxide/amine composite material disclosed by the present invention is used as an active material for the anode of a metal ion battery, which exerts the high electrochemical activity of the metal oxide material to the greatest extent.

In the above technical solution, the anionic metal oxide is one of titanium oxide, manganese oxide, niobium oxide, niobium titanium oxide, molybdenum oxide, tantalum oxide, and tungsten oxide. Specifically, titanium oxide is Ti₁₋ₙO₂⁴ⁿ⁻, 0<n<1; manganese oxide is MnO₂^{x-}, 0<x<1; niobium oxide is Nb₆O₁₇⁴⁻, Nb₃O₈⁻, LaNb₂O₇⁻, Ca₂Nb₃O₁₀⁻; niobium titanium oxide is TiNbO₅⁻, TiNb₆O₅⁻, Ti₂NbO₇⁻, Ti₅NbO₁₄³⁻; molybdenum oxide is MoO₂⁻, tantalum oxide is TaO₃⁻; tungsten oxide is W₂O₇²⁻ or Cs₄W₁₁O₃₆²⁻. In the above technical solution, the amine compound is a small molecule amine compound, and is a monoamine or a diamine, such as methylamine, ethylamine, n-propylamine, isopropylamine, n-butylamine, isobutylamine, sec-butylamine, tert-butylamine, n-amylamine, isoamylamine, sec-amylamine, tert-amylamine, n-hexylamine, n-heptylamine, n-octylamine, ethylenediamine, propylenediamine, butanediamine, pentamethylene diamine, hexamethylenediamine, diaminoheptane and diaminooctane, etc. Preferably, the amine compound is an alkylamine, preferably a linear alkylamine, more preferably a linear alkyl monoamine, preferably n-propylamine, n-butylamine, n-pentylamine, n-hexylamine, n-heptylamine, n-octylamine.

In the technical scheme, the anionic metal oxide solution and the amine compound solution are both aqueous solutions; wherein the total concentration of the anionic metal oxide in the anionic metal oxide aqueous solution is 1˜8 mg/mL; the volume concentration of the amine compound in the amine compound aqueous solution is 0.1˜10%. The volume ratio of the anionic metal oxide solution to the amine compound solution is 1:(0.8˜1.2).

The present invention discloses a metal ion battery anode, which comprises a current collector and an anode material positioned on the current collector, wherein the anode material comprises the layered metal oxide/amine composite material, a conductive agent and a binder; the current collector, the conductive agent and the binder are all existing products.

The present invention discloses a metal ion battery, which comprises an anode, electrolyte, a diaphragm and a cathode of the metal ion battery, wherein the electrolyte, the diaphragm and the cathode are all existing products.

The preparation method of the metal ion battery anode and the metal ion battery disclosed by the invention is a conventional technology and can comprise the following steps: mixing the layered metal oxide/amine composite material, a conductive agent and a binder in a solvent, and uniformly mixing and coating it on a current collector, and drying to form a metal ion battery anode; and then it is conventionally combined with a metal cathode, a diaphragm and electrolyte to obtain the metal ion battery. The metal ion battery is a magnesium ion battery, a lithium ion battery, a sodium ion battery and a zinc ion battery, etc.

The present invention utilizes the interlayer adjusting and controlling effect of the amine compound on the metal oxide to maintain the stability of the layered structure and exerts the high electrochemical activity of the metal oxide material to the greatest extent. When the material is applied to a magnesium ion battery, the performance is greatly improved, the specific capacity reaches 260 mAh/g, the maximum multiplying power is 5 A/g, the charge-discharge cycle can reach 2,000 times, and the material can stably work within the temperature range of −15° C. to +55° C. It solved the problem of poor multiplying power and poor cycle performance of existing magnesium ion batteries due to slow ion solid-state diffusion.

### BRIEF DESCRIPTION OF THE DRAWINGS

FIG. 1 shows an AFM image of titanium oxide nanosheet.

FIG. 2 shows a photo of standing titanium oxide solution mixed with aqueous solutions of propylamine, butylamine, amylamine, hexylamine and heptylamine compounds, respectively.

FIG. 3 shows an XRD pattern of a titanium oxide/alkylamine composite.

FIG. 4 shows an SEM pattern of a titanium oxide/hexylamine composite.

FIG. 5 shows a sectional HRTEM pattern of a titanium oxide/hexylamine composite.

FIG. 6 shows a FTIR and Raman plot of a titanium oxide/hexylamine composite.

FIG. 7 shows a photo of standing titanium oxide solution mixed with aqueous solutions of other amine compounds.

FIG. 8 shows the rate capability and cycle performance of the magnesium ion battery in Example 3.

FIG. 9 shows the temperature change test and GITT test performance of the magnesium ion battery in Example 3.

FIG. 10 shows the electrochemical performance of originally pure titanium oxide.

FIG. 11 shows the rate capability and cycle performance of titanium oxide/propylamine, titanium oxide/butylamine, titanium oxide/amylamine, titanium oxide/hexylamine, and titanium oxide/heptylamine composites.

FIG. 12 shows the XRD and charge and discharge graph of titanium oxide and metal ion flocculated material.

FIG. 13 shows the electrochemical performance of a manganese oxide/hexylamine composite.

### EXAMPLES OF THE PRESENT INVENTION

The invention is further described with reference to the following figures and Examples: the raw materials of the invention are all commercial products or products disclosed by the existing literature, and the specific preparation method and the test method are conventional methods in the field; for example, the amine compound is derived from Aladdin, >99% and is liquid. The creativity of the invention lies in that the small molecular amine compound and the anionic metal oxide are used as raw materials to prepare the layered metal oxide/amine composite material which is used as an active material for a magnesium ion battery at room temperature, and the performance is greatly improved.

A standard battery test system is used for the magnesium ion battery performance test, and the current range is 1 mA-10 mA. A constant temperature test box is used for the temperature change test of the battery, and the temperature is range from −30° C. to 100° C.

Preparation example: Preparation of anionic metal oxide can be referred to the patent already published by the inventor. Take the preparation of Ti_{1.74}O₄^{1.04-} for example. The remaining anionic oxides can be prepared by reference to conventional methods or can be obtained by conventional routes such as purchasing, gifting, etc.

The preparation of the titanium oxide Ti_{1.74}O₄^{1.04-} colloidal aqueous solution includes the following steps: TiO₂, K₂CO₃ and Li₂CO₃ were mixed at a molar ratio of 10.4:2.4:0.8, and placed in a muffle furnace at 800° C. for calcination for 20 hours to obtain a layered titanate precursor; the precursor was dispersed in 0.5 M hydrochloric acid solution and stirred for 72 h for protonation treatment, and a new hydrochloric acid solution was replaced every 24 hours during this period; and after protonation treatment, it was washed, sucked and dried, and the filter cake was finally dispersed in a tetramethylammonium hydroxide aqueous solution (25 wt %) for conventional oscillation for 7 days, and it was centrifugally cleaned to obtain titanium oxide (Ti_{1.74}O₄^{1.04-}) colloidal aqueous solution, and it was adjusted to the concentration of 5.0 mg/ml with water for the following experiments.

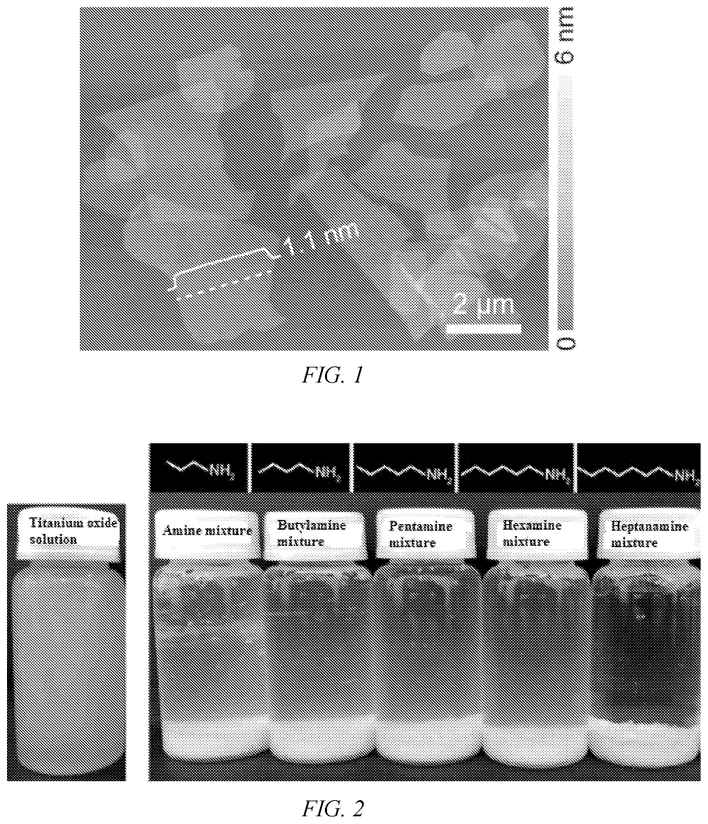

The titanium oxide colloid aqueous solution was dropped on a silicon substrate, and naturally spread to be dried naturally in the air to obtain the silicon substrate loaded with the titanium oxide nanosheet. It was characterized by Atomic Force Microscope (AFM), as shown in FIG. 1.

### Example 1

At room temperature, 5 mg/mL Ti_{0.87}O₂^{0.52-} aqueous solution (40 mL) and 40 mL of amine compound solution (0.2 mL of the amine compound) were stirred and mixed for 20 hours before standing for 15 minutes to show obvious layers, as shown in FIG. 2; the lower layer of solid was taken, centrifugally washed and freeze-dried for 48 hours (cold trap temperature −60° C.) to obtain a layered metal oxide/amine composite material in the form of solid powder.

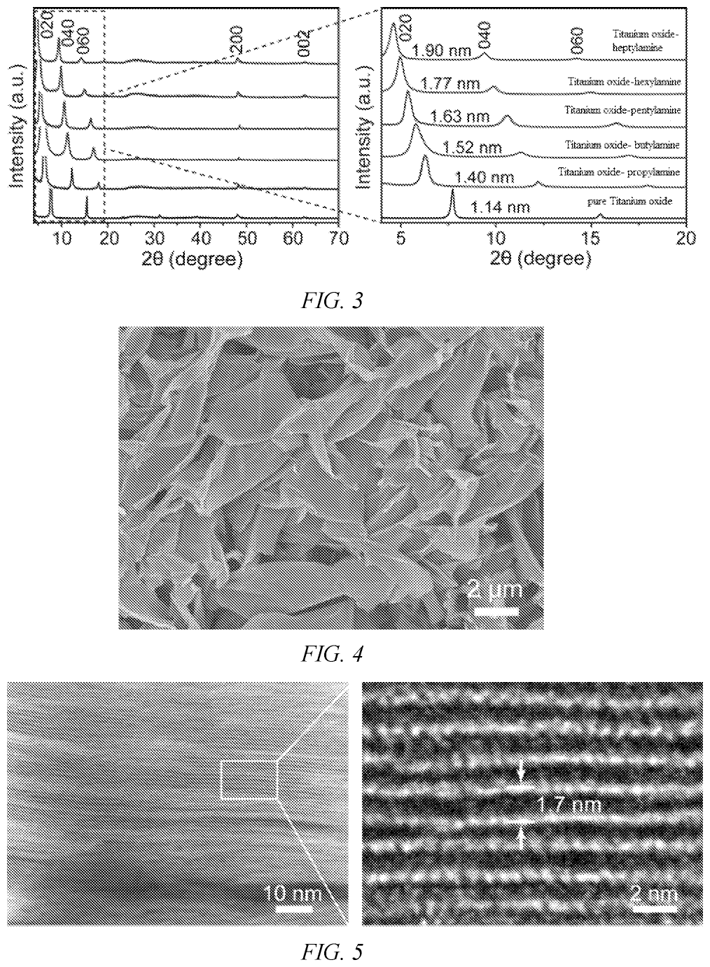

The amine compounds were n-propylamine, n-butylamine, n-amylamine, n-hexylamine and n-heptylamine respectively, and the corresponding products were titanium oxide/propylamine composite material, titanium oxide/butylamine composite material, titanium oxide/amylamine composite material, titanium oxide/hexylamine composite material and titanium oxide/heptylamine composite material which were used as active materials. FIG. 3 is an X-ray diffraction (XRD) pattern of the composite material, showing the greater spacing of the material.

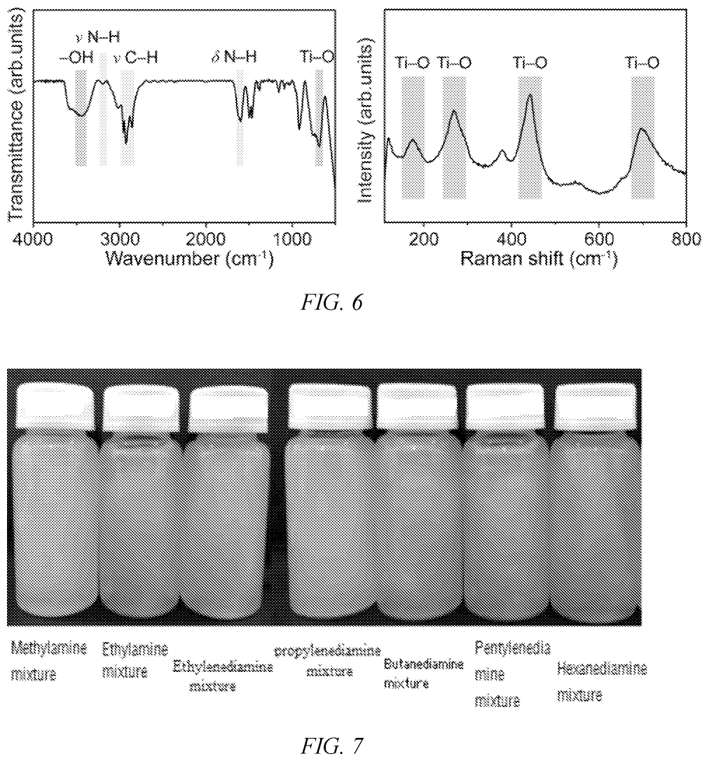

FIG. 4 shows a scanning electron microscope (SEM) pattern of a titanium oxide/hexylamine composite. FIG. 5 shows a high-resolution transmission electron microscopy (HRTEM) pattern of a titanium oxide/hexylamine composite, showing the layered stacking structure of the material. FIG. 6 shows an infrared spectroscopy (FTIR) and Raman spectrum (Raman) plot of a titanium oxide/hexylamine composite, demonstrating the successful combination of titanium oxide and hexylamine. If the lower layer of solid was taken and heated for drying, but not freeze-drying, the obtained product could be agglomerated and could not show the stacking morphology, that is to say, the layered composite material was not obtained.

### Example 2

At room temperature, 5 mg/mL Ti_{0.87}O₂^{0.52-} aqueous solution (40 mL) was stirred and mixed with 40 mL of methylamine, ethylamine, ethylenediamine, propylenediamine, butanediamine, pentamethylene diamine and hexamethylenediamine aqueous solution (0.2 mL of the amine compound) respectively for 20 hours before standing for 15 minutes, as shown in FIG. 7. There was no phenomenon of flocculation and delamination, and layered composite materials could not be obtained.

### Example 3

The titanium oxide/hexylamine composite material powder, Super P and PVDF binder were mixed in NMP in a mass ratio of 8:1:1, and stirred uniformly to be coated on the titanium foil and dried in a vacuum oven at 60° C. for 12 hours to obtain a positive electrode plate, wherein the loading amount of active material on the electrode was controlled at 1 mg/cm².

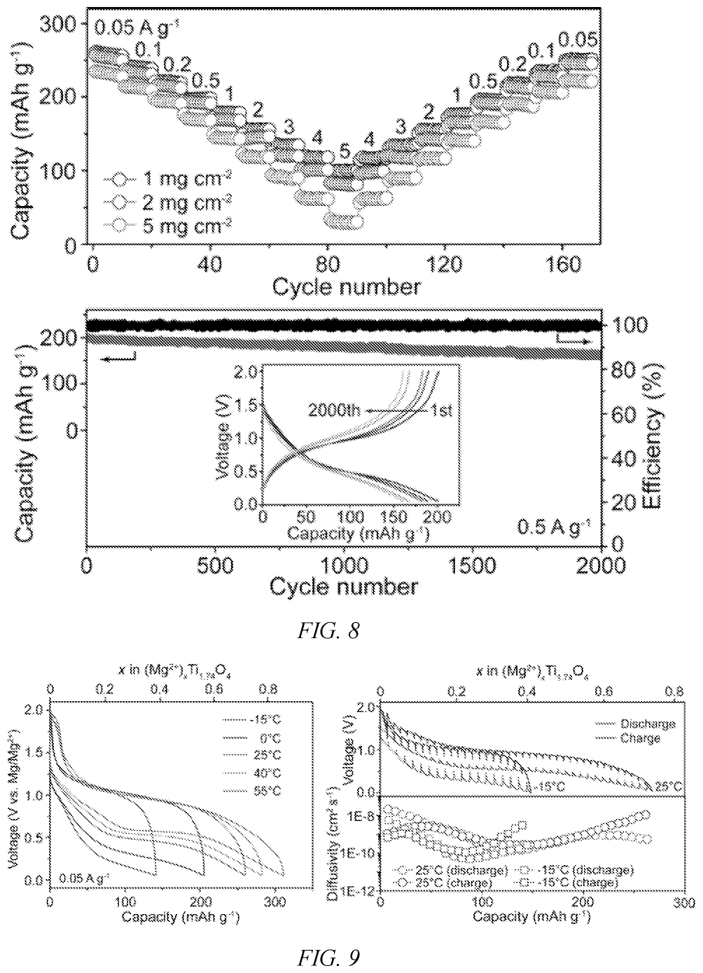

The positive electrode plate, metal magnesium foil as cathode, diaphragm (Whatman GF/D), and electrolyte (0.4 M 2PhMgCl—AlCl₃/THF) was assembled into a 2032 type button cell battery by conventional method to obtain a magnesium ion battery for conventional tests. FIG. 8 is a graph of the rate capability and cycle performance test of the above magnesium ion battery, wherein the specific capacity of the battery reached 260 mAh/g at a low rate of 0.05 A/g, the highest rate could reach 5 A/g, and the capacity could still be maintained at 100 mAh/g; and the battery could stably cycle for up to 2,000 times at room temperature, which showed that the battery had excellent magnesium storage performance. FIG. 9 is a graph showing the temperature change test and the ion diffusion test of the above-mentioned magnesium ion battery, which could stably operate in the temperature range of −15° C. to +55° C. and had practical application value. The diffusion calculation of magnesium ions in the composite material could be measured by a galvanostatic intermittent titration technique (GITT), and the test result showed that the diffusion rate reached 10⁻⁸˜10⁻¹⁰ cm² s⁻¹ at room temperature, that is to say, it could still be maintained at the level of 10⁻⁹˜10⁻¹¹ cm² s⁻¹ at the low temperature of −15° C., showing that the prepared composite material could provide a fast transport path for magnesium ions, ensuring the high-performance operation of magnesium ion batteries.

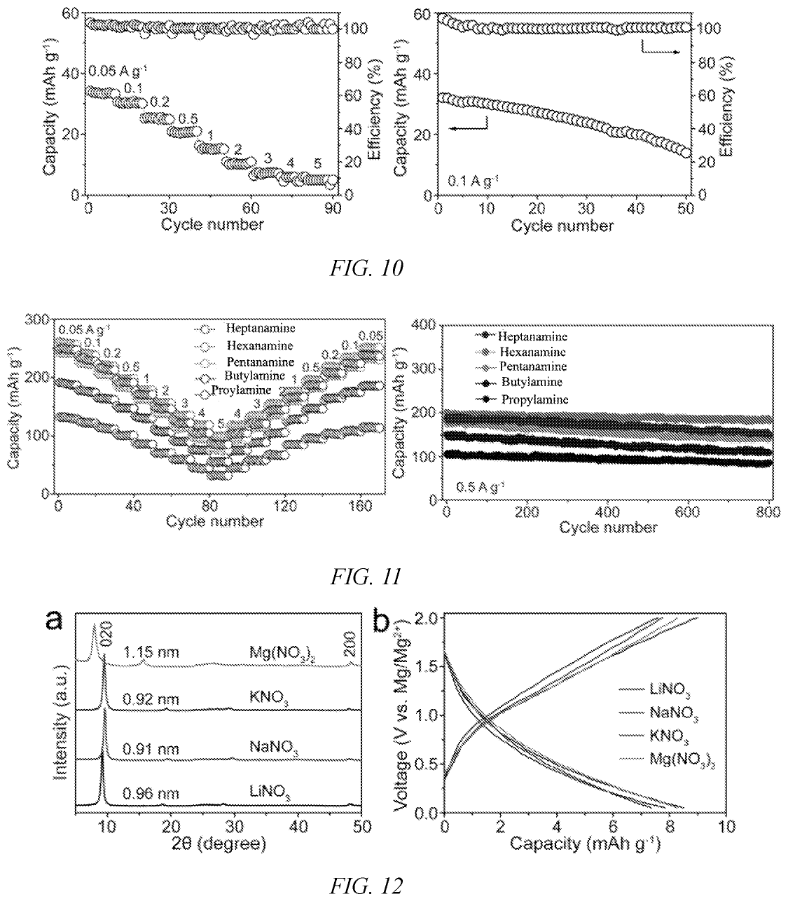

The same experiment was conducted by replacing the titanium oxide/hexylamine composite powder with pure titanium oxide for comparison, and the magnesium ion battery obtained by using the originally pure titanium oxide as the positive electrode material showed extremely poor electrochemical performance. FIG. 10 is a graph of rate capability and cycle performance, with the low capacity of only 35 mAh/g available at the low rate of 0.05 A/g, and with only 50 cycles.

### Example 4

And replacing the titanium oxide/hexylamine composite material in the Example 3 with a titanium oxide/propylamine composite material, a titanium oxide/butylamine composite material, a titanium oxide/amylamine composite material and a titanium oxide/heptylamine composite material, and keeping the others unchanged to obtain the magnesium ion battery based on different active materials. FIG. 11 is a graph of rate capability and cycle performance, with the titanium oxide/hexylamine composite material showing the optimum performance.

### Control

40 mL of each 5 mg/mL of Ti_{0.87}O₂^{0.52-} aqueous solution and 0.1 mol/L of nitrate aqueous solution were added to obtain a mixed solution before standing. Then the lower-layer precipitate was taken to be freeze-dried to obtain solid powder of the composite material. The solid powder of the composite material, Super P and PVDF binder were mixed in NMP in a mass ratio of 8:1:1, and stirred uniformly to be coated on the titanium foil and dried in a vacuum oven at 60° C. for 12 hours to obtain a positive electrode plate.

The positive electrode plate, metal magnesium foil as cathode, diaphragm (Whatman GF/D), and electrolyte (0.4 M 2PhMgCl—AlCl₃/THF) was assembled into a 2032 type button cell battery (refer to Example 3) to obtain a magnesium ion battery, and the nitrate was lithium nitrate, sodium nitrate, potassium nitrate or magnesium nitrate. FIG. 12 is an XRD pattern of the above composite material and a performance diagram of a magnesium ion battery, wherein the interlayer distance was small and the battery was almost unable to charge and discharge normally.

### Example 5

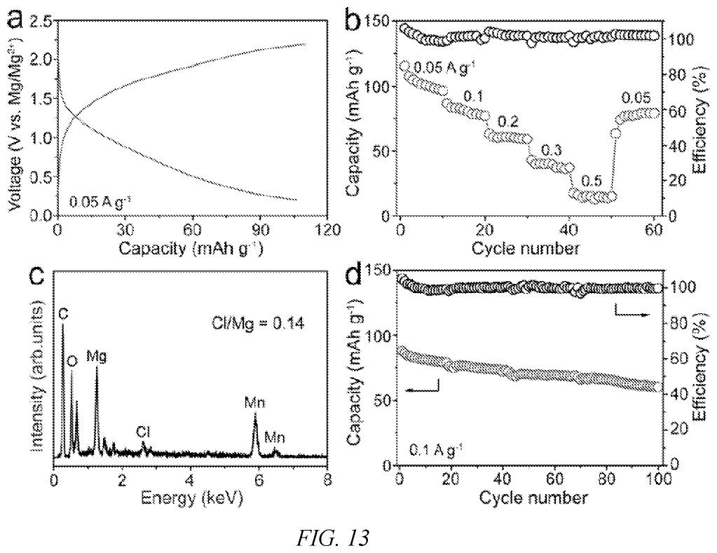

5 mg/mL MnO₂^{0.4-} aqueous solution (40 mL) and 40 mL n-hexylamine aqueous solution (0.2 mL of n-hexylamine) were stirred and mixed for 20 hours before standing for 15 minutes. Then the lower-layer solid was taken to be freeze-dried to obtain solid powder of the composite material. The solid powder of the composite material powder, Super P and PVDF binder were mixed in NMP in a mass ratio of 8:1:1, and stirred uniformly to be coated on the titanium foil and dried in a vacuum oven at 60° C. for 12 hours to obtain a positive electrode plate, wherein the loading amount of active material was controlled at 1 mg/cm². The positive electrode plate, metal magnesium foil as cathode, diaphragm (Whatman GF/D), and electrolyte (0.4 M 2PhMgCl—AlCl₃/THF) was assembled into a 2032 type button cell battery to obtain a magnesium ion battery. FIG. 13 is a graph of the rate capability and cycle performance test of the magnesium ion battery, wherein the specific capacity of the battery reached 105 mAh/g at a low rate of 0.05 A/g, the highest rate could reach 0.5 A/g, and the capacity could still be maintained at 100 mAh/g. And the battery could stably cycle for up to 1,000 times at the rate of 0.1 A/g.

Referring to the method of the Example 3, the above powder can be used for preparing a positive electrode plate, and further assembled into a magnesium ion battery.

The present invention combined amine compound with anionic metal oxide for the first time to obtain a layered material used for metal ions, particularly magnesium ion positive electrode, which had excellent performance as an active material. The test result showed that the diffusion rate reached 10⁻⁸˜10⁻¹⁰ cm² s⁻¹ at room temperature, that is to say, it could still be maintained at the level of 10⁻⁹˜10⁻¹¹ cm² s⁻¹ at the low temperature of −15° C., showing that the prepared composite material could provide a fast transport path for magnesium ions, ensuring the high-performance operation of magnesium ion batteries.

1. A layered metal oxide/amine composite material prepared from an anionic metal oxide and an amine compound.

2. The layered metal oxide/amine composite material according to claim 1, wherein the anionic metal oxide is titanium oxide, manganese oxide, niobium oxide, niobium titanium oxide, molybdenum oxide, tantalum oxide, or tungsten oxide; the amine compound is a small molecule amine compound.

3. The layered metal oxide/amine composite material according to claim 2, wherein titanium oxide is Ti₁₋ₙO₂⁴ⁿ⁻, 0<n<1; manganese oxide is MnO₂^{x-}, 0<x<1; niobium oxide is Nb₆O₁₇⁴⁻, Nb₃O₈⁻, LaNb₂O₇⁻, Ca₂Nb₃O₁₀⁻; niobium titanium oxide is TiNb₆O₅⁻, TiNb₆O₅⁻, Ti₂NbO₇⁻, or Ti₅NbO₁₄³⁻; molybdenum oxide is MoO₂⁻, tantalum oxide is TaO₃⁻; tungsten oxide is W₂O₇²⁻ or Cs₄W₁₁O₃₆²⁻; the amine compound is an alkylamine.

4. The layered metal oxide/amine composite material according to claim 3, wherein the amine compound is a linear alkylamine.

5. A method of preparing the layered metal oxide/amine composite material according to claim 1, comprising mixing an anionic metal oxide solution and an amine compound solution to obtain a precipitate; and then drying the precipitate to obtain the layered metal oxide/amine composite material.

6. The method of preparing the layered metal oxide/amine composite material according to claim 5, wherein the anionic metal oxide solution and the amine compound solution are both aqueous solutions; wherein a total concentration of the anionic metal oxide in the anionic metal oxide aqueous solution is 1˜8 mg/mL; a volume concentration of the amine compound in the amine compound aqueous solution is 0.1˜10%.

7. A metal ion battery anode, comprising a current collector and an anode material positioned on the current collector, wherein the anode material comprises the layered metal oxide/amine composite material according to claim 1, a conductive agent and a binder.

8. A metal ion battery, comprising the metal ion battery anode according to claim 7, electrolyte, a diaphragm and a cathode.

9. Use of the amine compound in the preparation of the layered metal oxide/amine composite material according to claim 1.

10. Use of the layered metal oxide/amine composite material according to claim 1 in preparing metal ion batteries.
